(19) United States
(12) Patent Application Publication
(10) Pub. No.: US 2024/0252852 A1
(43) Pub. Date: Aug. 1, 2024

(54) INTEROPERABLE RESPIRATORY MASK SYSTEM

(71) Applicant: NP Medical Inc., Clinton, MA (US)

(72) Inventors: Todd Chelak, Pelham, NH (US); Nicholas Illsley, Sterling, MA (US)

(21) Appl. No.: 18/565,428

(22) PCT Filed: Jun. 4, 2021
(86) PCT No.: PCT/US21/35924

§ 371 Date: Nov. 29, 2023

(51) Int. Cl. A62B 18/02; A62B 23/02

(52) U.S. Cl. CPC A62B 18/025; A62B 23/025

(57) ABSTRACT

A respirator mask system protects a user against inhalation of undesirable airborne substances and includes a body and a casing. The body has a proximal portion with a first opening that accommodates the user's face, and a main portion with a second opening to the interior. The casing is attached to the body and encloses the second opening to prevent the flow of air therethrough. The casing is formed from a softer material than that of the body. The respirator mask system also includes a filter device that filters out at least a portion the undesirable airborne substances between the surrounding environment and the interior while the user is breathing. An accessory may interact with at least the casing, and at least a portion of the accessory may gain access to the interior. A stem of the accessory engages the casing when the accessory interacts with the casing.

### TECHNICAL FIELD

The present invention relates to respirator masks, and more particularly to an interoperable respirator mask system and accessories that may be used with the respirator mask system.

### BACKGROUND ART

Respirators and respirator masks are used in many applications to protect the user from undesirable airborne substances and particulates. Such respirators typically include a face mask with a filter structure that filters out the undesirable airborne substances and particulates so that the user does not breathe them in. The face piece structures for reusable respirator masks, which require cleaning at regular intervals, tend to be comprised of a rigid body to enable users to connect various components (e.g. filters, head harnesses) and a soft sealing element for placement against the user's face. However, the rigid body reduces the ability of a user to gain access to the interior of the mask for various purposes (e.g. to establish a flow “port” for a user fit test that is conducted during mask selection).

Conversely, if the reusable face piece body is instead fabricated from a less rigid material for it to be easier to breach, the structure loses strength/stability making it vulnerable to crushing/collapsing while attaching various components and during inhalation cycles. For example, during fit testing of the respirator, the mask may crush/collapse, making it difficult to appropriately fit test.

### SUMMARY OF THE INVENTION

In accordance with one embodiment of the invention, a respirator mask system protects a user against inhalation of undesirable airborne substances within a surrounding environment when donned by the user. The respirator mask system may include a body and a casing. The body may have a proximal portion with a first opening to an interior, and a main portion with a second opening to the interior. The first opening may accommodate the user's face, and the body may be formed from a first material. The casing may be attached to the body and may enclose the second opening to prevent the flow of air therethrough. The casing may be formed from a second material that is softer than the first material. A filter device may filter out at least a portion of the undesirable airborne substances between the surrounding environment and the interior while the user is breathing. An accessory may have a stem and may interact with at least the casing. A portion of the accessory may gain access to the interior, and the stem of the accessory may engage the casing when the accessory interacts with the casing.

In some embodiments, a portion of the casing may circumscribe the first opening. Additionally or alternatively, the filter device may be a disposable filter cartridge and/or the body may include threads. The disposable filter cartridge may thread onto the body or the disposable filter cartridge may snap onto the body. The respirator mask system may also include a head strap that may be placed around the head of the user to secure the respirator mask system to the user. For example, the head strap may have a locking clip configured to tension and secure the head strap.

In other embodiments, the casing may include at least one normally closed slit that at least partially extends through the casing. A portion of the accessory may act upon the slit(s) when interacting with the casing. The casing may also have a thickened area at least partially surrounding the at least one normally closed slit. Additionally or alternatively, the stem of the accessory may have a protrusion that engages the slit(s) to secure the accessory to the respirator mask system.

The accessory may be an exhalation valve system. Additionally or alternatively, the accessory may be a fit-test port having a fit test grommet and the stem. The fit test grommet may engage an exterior of the casing, and the stem may engage an interior of the casing and extend through the casing and fit test grommet. The accessory may include a sensor that monitors the interior or the surrounding environment. The stem may have a housing that engages the casing and restricts access to the exterior. The sensor may include a carbon dioxide sensor, a contaminant sensor, a temperature sensor, a humidity sensor, and/or a pressure sensor.

In other embodiments, the accessory may be a label button, a hydration system, and/or a strap retainer. In embodiments in which the accessory is a hydration system, the hydration system may have a tube that extends from a fluid container to the interior. If the accessory is a strap retainer, the stem may secure the strap retainer to the casing when engaged with the casing. The strap retainer may include (1) a strap retainer body extending from the stem, and (2) a channel extending through the strap retainer body. The channel may receive a head strap to allow the head strap to pass through the strap retainer body. In some embodiments, the accessory may include a body interacting element that interacts with the body. The body interacting element may extend through a hole within the body when interacting with the body.

In accordance with other embodiments, a method for protecting a user against inhalation of undesirable airborne substances within a surrounding environment may include providing a respirator mask system that has a body and a casing. The body may have a proximal portion with a first opening to an interior, and a main portion with a second opening to the interior. The first opening may accommodate the user's face and the body may be formed from a first material. The casing may be attached to the body and enclose the second opening to prevent the flow of air therethrough. The casing may be formed from a second material that is softer than the first material. A filter device may filter out a portion of the undesirable airborne substances between the surrounding environment and the interior while the user is breathing. An accessory may have a stem and may interact with at least the casing. A portion of the accessory may gain access to the interior, and the stem of the accessory may engage the casing when the accessory interacts with the casing. The method may also include placing the user's face adjacent the first opening of the body, for example, such that the respirator mask system seals against the user's face. The method may then secure the respirator mask system to the user. The respirator mask system may include a head strap, and securing the respirator mask system to the user may include placing the head strap around the head of the user and tightening the head strap.

### BRIEF DESCRIPTION OF THE DRAWINGS

The foregoing features of embodiments will be more readily understood by reference to the following detailed description, taken with reference to the accompanying drawings, in which:

FIGS. 1A and 1B schematically show perspective views of an interoperable respirator mask system, in accordance with various embodiments of the present invention.

FIG. 2 schematically shows a perspective view of a body of the respirator mask system shown in FIGS. 1A and 1B, in accordance with some embodiments of the present invention.

FIG. 3 schematically shows a perspective view of a casing of the respirator mask system shown in FIGS. 1A and 1B, in accordance with some embodiments of the present invention.

FIGS. 4A and 4B schematically show perspective views of the interoperable respirator mask system of FIGS. 1A and 1B with a filter device attached, in accordance with various embodiments of the present invention.

FIG. 5 schematically shows perspective views of the interoperable respirator mask system of FIGS. 1A and 1B with a filter device attached and a head strap, in accordance with various embodiments of the present invention.

FIG. 6 schematically shows interoperable respirator mask system feature(s) that facilitate the interacting between an accessory and the respirator mask, in accordance with some embodiments of the present invention.

FIGS. 7A-7C schematically show a fit test port interacting with/connecting to the respirator mask system shown in FIGS. 1A and 1B, in accordance with some embodiments of the present invention.

FIGS. 8A-8C schematically show an exhalation valve system interacting with/connecting to the respirator mask system shown in FIGS. 1A and 1B, in accordance with some embodiments of the present invention.

FIGS. 9A-9B schematically show a sensor system interacting with/connecting to the respirator mask system shown in FIGS. 1A and 1B, in accordance with some embodiments of the present invention.

FIGS. 10A-10C schematically show a label button system interacting with/connecting to the respirator mask system shown in FIGS. 1A and 1B, in accordance with some embodiments of the present invention.

FIGS. 11A-11B schematically show a hydration system interacting with/connecting to the respirator mask system shown in FIGS. 1A and 1B, in accordance with some embodiments of the present invention.

FIGS. 12A-12D schematically show a strap retainer system interacting with/connecting to the respirator mask system shown in FIGS. 1A and 1B, in accordance with some embodiments of the present invention.

### DETAILED DESCRIPTION OF SPECIFIC EMBODIMENTS

In illustrative embodiments, a respirator mask system protects a user against inhalation of undesirable airborne substances within a surrounding environment. The respirator mask system has a casing that is attached to a body and encloses an opening within the body. A number of accessories may be used in conjunction with the respirator mask. To help/allow the accessory to breach the respirator mask, but not allow the mask to be vulnerable to undesirable crushing/collapsing, the material of the casing may be softer than that of the body. Details of illustrative embodiments are discussed in greater detail below.

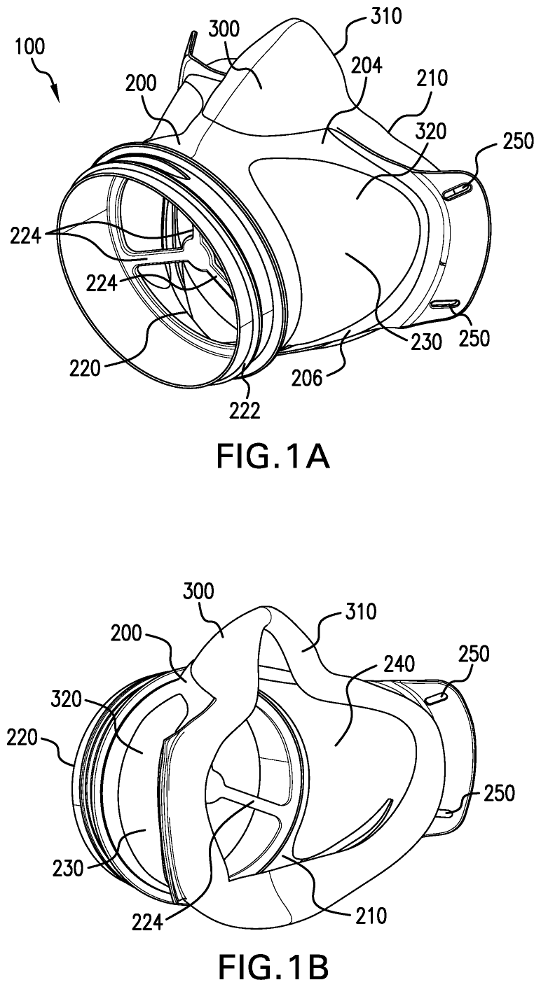

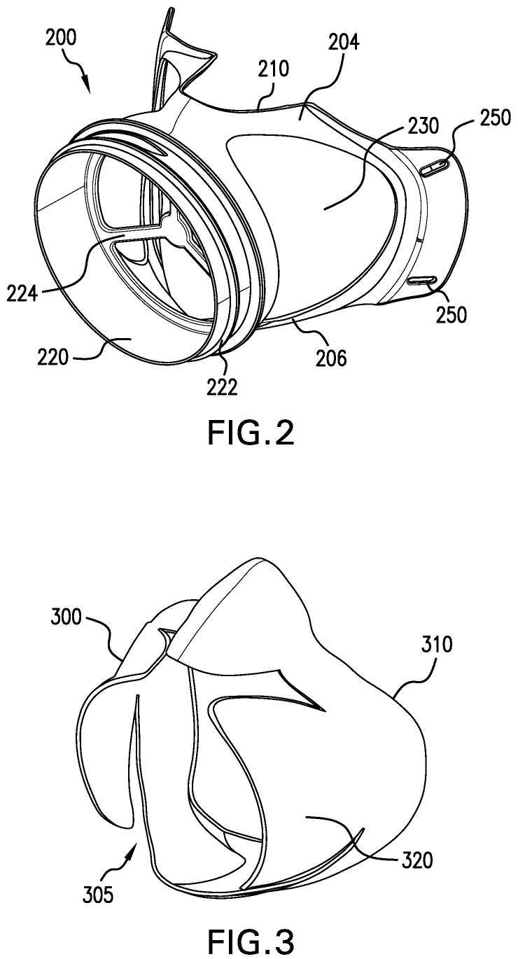

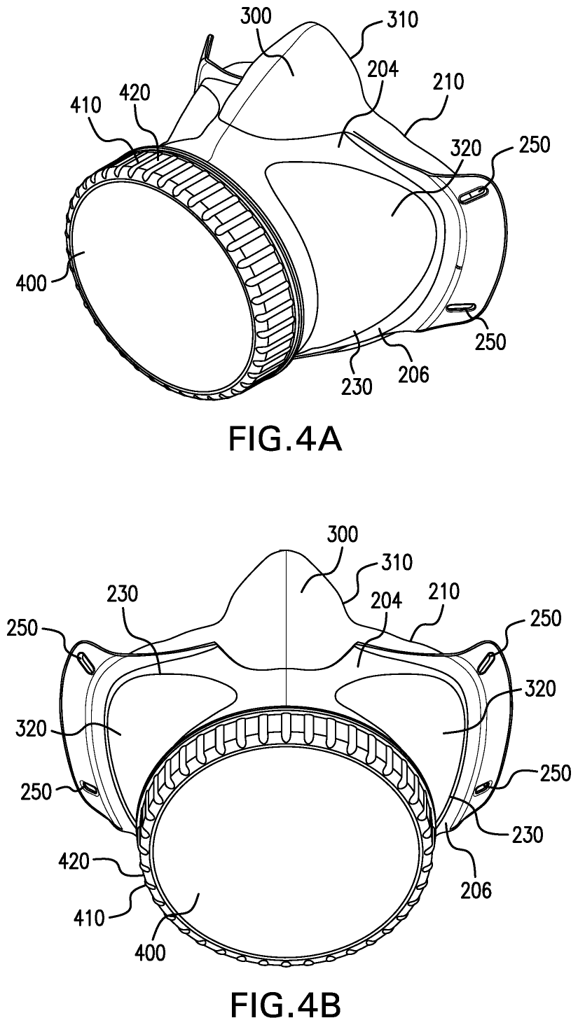

FIGS. 1A and 1B schematically show a respirator mask system 100 that may be donned by a user to protect the user from undesirable airborne substances within a surrounding environment. To define the overall structure of the respirator mask 100, the mask 100 may include a body 200 (see FIG. 2). At the back end of the body 100 (e.g., within a proximal portion 204 of the body), the body 100 may include an opening 210 (e.g., a facial opening) that may receive/accommodate the user's face when the respirator system 100 is donned by the user. At the opposing end (e.g., at the front of the body 100), the body 200 may have an additional opening 220 (e.g., a filter opening) to which a filter device 400 (discussed in greater detail below) may be connected. To facilitate the connection of the filter device 400, the body 200 and/or the additional opening 220 may include threads 222 and/or snap connections. Additionally, to provide some structural rigidity, the body 200 may have structural members 224 located within the additional/filter opening 220.

As noted above, the respirator mask system 100 may include and/or interact with an accessory for the respirator mask system 100. To that end, the body 200 may have a further opening 230 (e.g., an accessory opening), for example, located on the side of the body 200 (e.g., within a main portion 206 of the body). The opening 230 may extend into the interior 240 of the body 200/respirator mask system 100 to allow the accessory to gain access to the interior 240. The body 200 may also include one or more slots 250 (e.g., four slots—two on each side of the body 200) extending through at portion of the body 200 to allow a head strap to be secured to the respirator mask system 100 (discussed in greater detail below).

In addition to the body 200, the respirator mask system 100 may also include a casing 300 (see FIG. 3) that is attached/secured to the body 200, for example, to an interior surface of the body 200. The casing 300 may include a first portion 310 located at one end of the casing 300 that circumscribes the first/face opening 210 of the body 200. When the respirator mask system 100 is donned by the user, the first portion 310 of the casing 300 may contact and/or seal again the user's face and may be shaped to facilitate contact with the user's face and enhance user comfort. As discussed in greater detail below, the casing 300 may be formed from softer/more flexible (i.e. more elastic) material than that of the body 200. This softer/more flexible material is more comfortable for the user as compared to the more rigid material of the body 200. Additionally, the softer/more flexible material provides better sealing against the user's skin/face.

At the opposing end of the first portion 310, the casing 300 may have an open end 305 to allow airflow into and out of the interior 240 through the filter device 400 when the user breathes. The casing 300 may also have a second portion 320 that encloses the second opening 230 (e.g., the accessory opening in the body 200) to prevent the flow of air through the second opening 230. The casing 300 may be attached/secured to the body in a number of ways. For example, the casing 300 may be secured/attached to the body by an adhesive, press-fit/interference fit, ultrasonic welding, and/or chemical bonding, to name but a few. Additionally or alternatively, the casing 300 and the body 200 may be manufactured using two-shot or over-molding manufacturing processes.

As discussed above, the body 200 and the casing 300 may be made from different materials. For example, the body 200 may be made from a stiffer/more rigid material than the casing 300 which may be made from softer/more flexible material (e.g. silicone, thermoplastic elastomer, or a blend of softer and stiffer materials). This combination of materials provides the respirator mask system 100 with sufficient structural rigidity but provides softer contact surfaces for the user. Additionally, the properties of the softer/more flexible material (e.g. elasticity) of the casing 300 allows various embodiments of the present invention to utilize/interact with accessories that gain access to the interior 240 of the mask 100.

As noted above, the respirator mask system 100 may include a filter 400 that connects to the front opening 220 of the body 200. For example, the filter 400 may be a filter cartridge that threads or snaps onto the body 200 and filters out undesirable airborne substances (e.g., particulates, chemicals, etc.) within a surrounding environment. The filter 400 may be replaceable and interchangeable such that different types of filters 400 may be attached and replaced (e.g., a particulate filter may be replaced with a chemical filter and vice versus). To facilitate connection and removal of the filter cartridge, the filter 400 (e.g., the cartridge) may include indents 410 and/or protrusions 420 that the user may grasp during connection/removal.

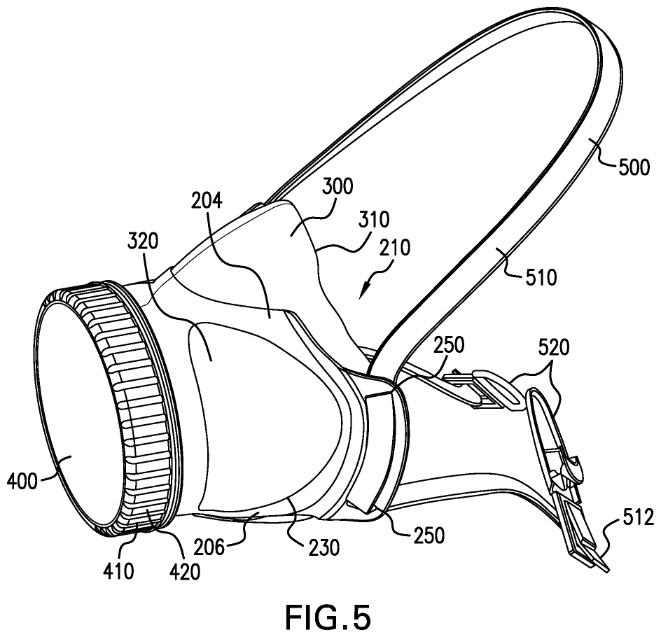

As shown in FIG. 5, some embodiments may include a head strap 500 that may be used to secure the respirator mask system 100 to the user. For example, the head strap 500 may include a strap 510 that may be fed through the slots 250 within the body 200 to attach the head strap 500 to the body 200 and remainder of the respirator mask system 100. At the ends of the strap 510, the head strap 500 may have a locking clip 520 that secures the ends of the strap 510 together and allows for custom tensioning/fitment of the head strap 500 and respirator mask system 100. For example, one end 512 of the strap 510 may pass through a portion of the locking clip 520. During use and donning of the respirator mask system 100, the user may place the respirator mask system 100 over their face and the head strap 500 over their head. The user may then connect the two ends of the locking clip 510 and pull end 512 of the strap to adjust the tension and fitment of the head strap 500 and respirator mask system 100. Additionally, the strap 510 may have an elastic characteristic to facilitate tensioning and fitment. Although not shown, several alternative methods are also known and contemplated for the mounting of the head strap 500 to the respirator mask system 100 (e.g. rivets, hooks, brackets, etc.) as well as for adjusting the tension and fitment (e.g. clasps, ties, etc.).

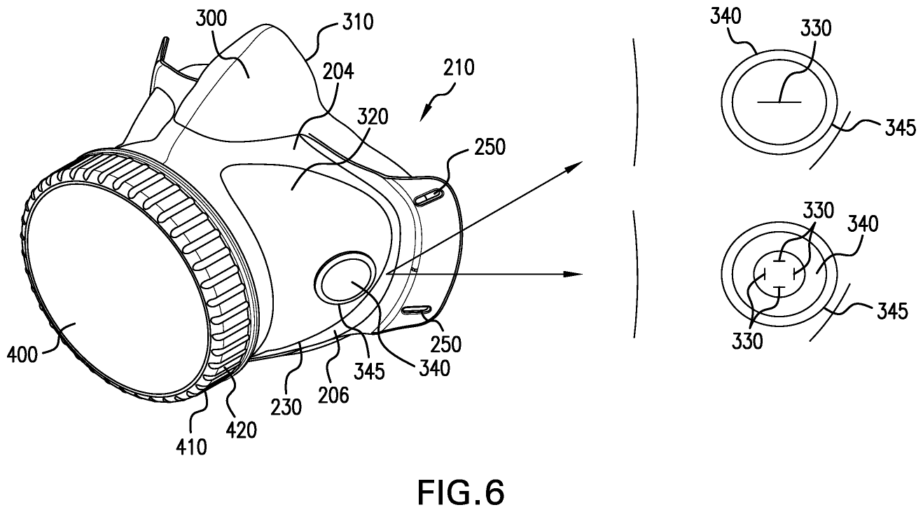

As noted above, the respirator mask system 100 may be used in conjunction with a number of possible accessories that access the interior 240 of the respirator mask system 100. To that end, the casing 300 may have various features that facilitate access to the interior 240 of the respirator mask system 100. For example, as shown in FIG. 6, the casing 300 may have one or more normally closed slits/aperture(s) 330 that extend at least partially through the second portion 320 of the casing to facilitate breaching of the casing 300 by the accessory (e.g., so that the accessory can access the interior 240) or otherwise facilitating access to the interior (e.g., without piercing). In such embodiments and as discussed in greater detail below, the various accessories may include a stem that passes through the slit/aperture 330 to access the interior 240 and/or a stem that interacts with the casing 300 to open the slit(s)/aperture(s) 330 when gaining access to the interior 240.

The slits(s)/aperture(s) 330 may be formed during and/or after the fabrication of the casing 300. During formation of the slit/aperture 330, the material of the casing 300, especially if attached to body 200 may release internal stresses within the casing 300. These released stresses and associated forces may act upon the slit/aperture(s) 330, causing the slit/aperture(s) 330 to move towards an open state. To counteract these forces and movements, some embodiments of the casing 300 may have thicker and/or thinner areas at least partially surrounding the aperture(s)/slit(s) 330. For example, the casing 300 may have a first thickened area 340 and a second thickened area 345 that is thicker than the first thickened area 340. These thickened areas 340/345 help control the shrinkage of the casing 330, particularly around the slit/aperture(s) 330 (e.g., so that the slit/aperture(s) 330 remains closed).

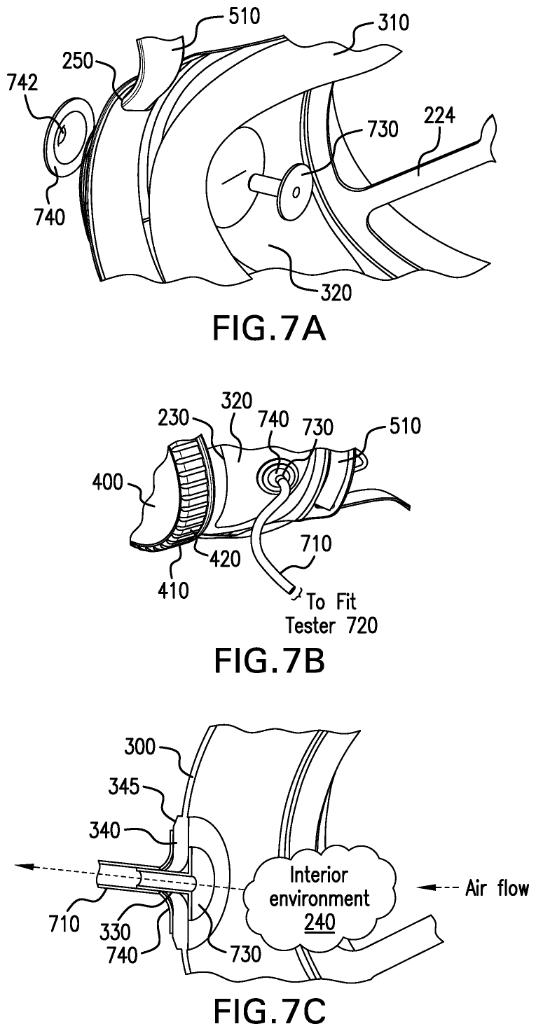

As noted above, the respirator mask system 100 may include and/or interact with an accessory that may gain access to the interior 240. FIGS. 7A to 12D schematically show some exemplary accessories that may be used with various embodiments of the present invention. It should be noted that, because the aperture(s)/slit(s) 330 that the accessories use to connect to the respirator mask system 100 are normally closed (e.g., they remain closed when an accessory is not connected), the accessories may be removed, replaced and interchanged as needed/desired. The accessories shown in FIGS. 7A to 12D are merely exemplary accessories and any number of accessories may be used.

In order to ensure proper fitment of the respirator mask system 100, in many instances it may be desirable to perform a fit test of the respirator mask system 100 on the user. To that end, FIGS. 7A to 7B show a fit-test accessory (e.g., a fit test port 700). The fit test port 700 may include a tube 710 that leads to the fit tester 720 that, in turn, applies the necessary pressure/vacuum to ensure proper fitment of the respirator mask system 100. To secure the fit test port 700 to the respirator mask system 100, the fit test port 700 may include a fit test stem 730 that extends through the normally closed aperture/slit 330 to allow the fit test port 700 to gain access to the interior 240 and place the tube 710 in fluid communication with the interior 240. A portion of the fit test stem 730 (e.g., a flange 732 of the stem 730) may contact or otherwise interact with the interior of the casing 300. On the outside of the respirator mask system 100, the fit test port 700 may have a grommet 740 that engages/contacts the exterior of the casing 300. The fit test stem 730 may extend through an opening 742 in the grommet 740 and the tube 710 may fit over the end of the stem 730.

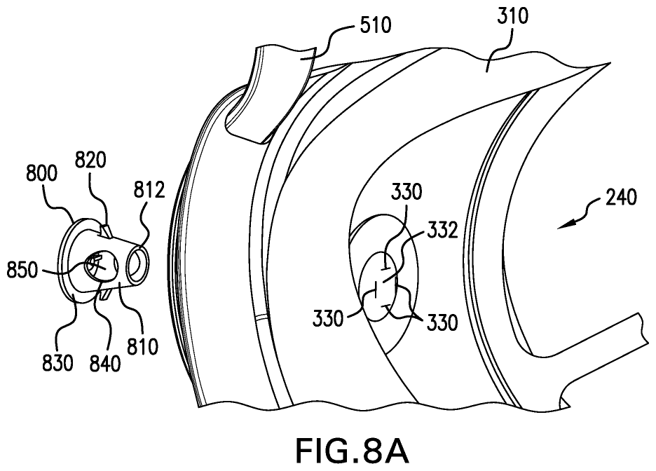

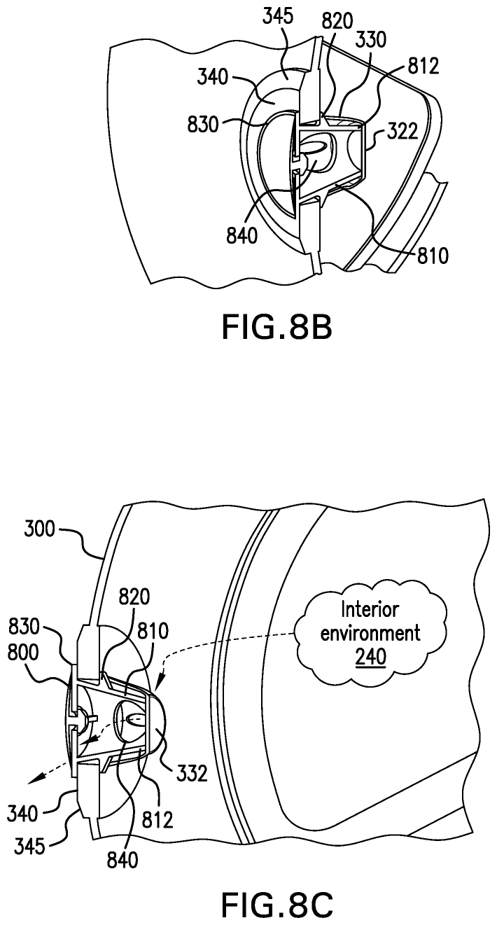

FIGS. 8A to 8C show an exemplary exhalation valve 800 that may be used as the accessory for the respirator mask system 100 to help the user exhale easier when wearing the mask. The exhalation valve 800 may have stem 810 that enters or otherwise gains access to the interior 240 of the respirator mask system 100 via the normally closed aperture(s)/slit(s) 330. It should be noted that FIGS. 8A to 8C show a casing 300 that has four apertures/slits 330 arranged to form a generally square shape. To that end, when the exhalation valve 800 is attached to the respirator mask system 100, it does not necessarily completely “pierce” the casing 300/apertures 330. Rather, the stem 810 may merely deform the casing 300 to open the apertures/slits 330 and a portion of the casing (e.g., the portion 332 located in the middle of the apertures 330) may cover the end 812 of the stem 800. To help secure the exhalation valve 800 to the casing 300 and the respirator mask system 100, the exhalation valve 800 (e.g., the stem 810) may have one or more protrusions/snaps 820 that engage the casing 300. Additionally, the exhalation valve 800 may have a flange 830 that engages the outside of the casing 300 when the valve 800 is attached to the respirator mask system 100. During use and as the user exhales, the user's breath may pass through the now open apertures/slits 330, through openings 840 within the stem 810, into the interior 850 of the valve 800 and out of the valve 800 into the outside environment.

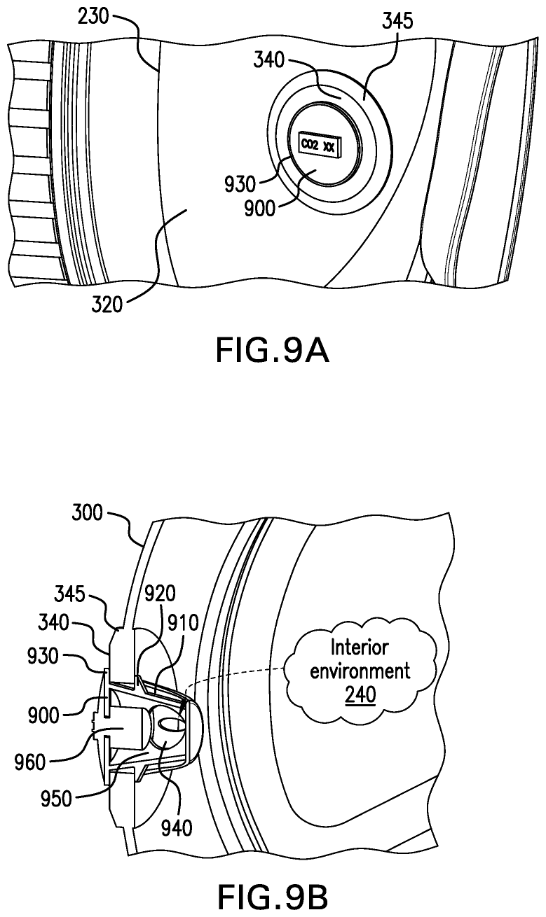

FIGS. 9A and 9B show an exemplary sensor accessory 900. The sensor accessory 900 may have a similar structure as that described above for the exhalation valve 800. For example, the sensor accessory 900 may have a stem 910 that extends into the interior 240 and opens the apertures/slits 330, one or more protrusions/snaps 920 that engage the casing 300 to secure the sensor accessory 900 to the respirator mask system 100, a flange 930 that engages the outside of the casing 300 when the sensor accessory 900 is attached to the respirator mask system 100, and opening(s) 940 into the interior 950. Within the interior 950, the sensor accessory 900 may have a sensor 960 that can detect/monitor any number criteria within the interior 240 of the respirator mask system 100 and/or the surrounding environment. For example, the sensor 960 may measure/monitor/detect carbon dioxide, contaminant levels, temperature, humidity, pressure (e.g., for possible filter occlusions), to name but a few. In some embodiments, the sensor accessory 900 may engage the casing 300 and restrict access to the exterior when accessing the interior 240.

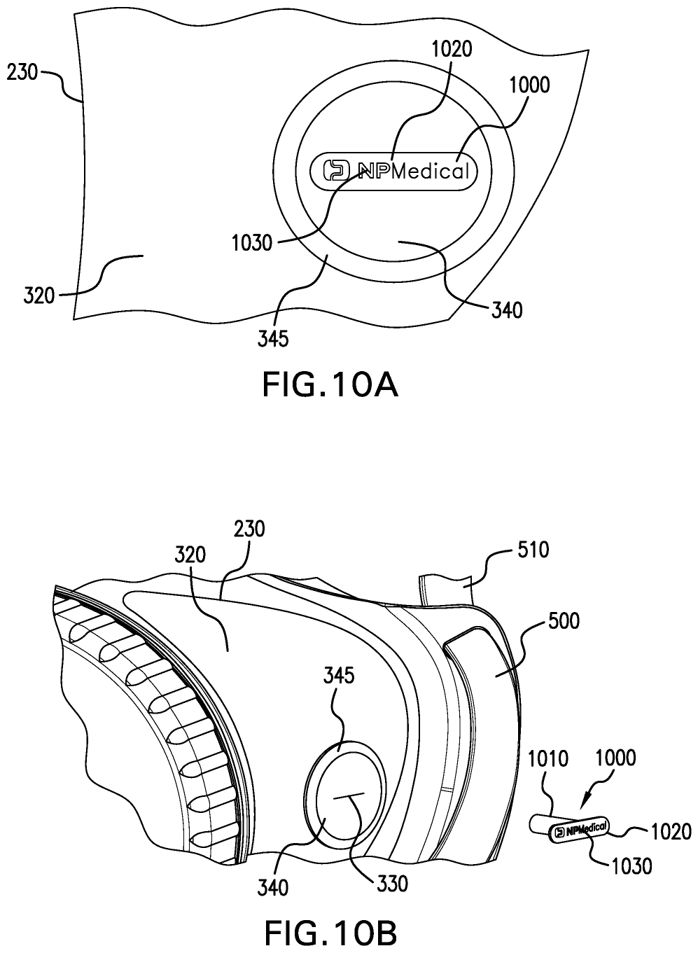

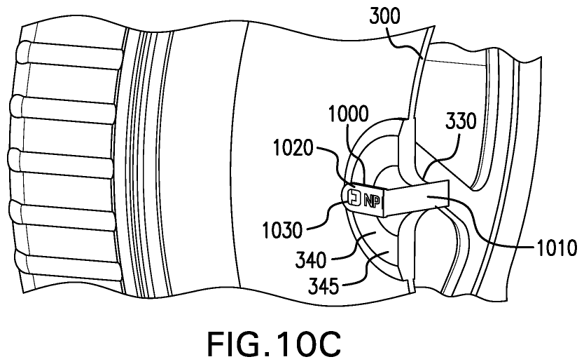

In some instances, it may be necessary or desirable to label the respirator mask system 100, for example, with manufacturer information, product information and/or user information. To that end and as shown in FIGS. 10A-10C, the accessory may be a label button 1000. The label button 1000 may include a stem 1010 that engages/interacts with the aperture(s)/slit(s) 330 to gain access to the interior 240 and secure the label button 1000 to the respirator mask system 100. For example, if the respirator mask system 100 includes a single normally closed aperture/slit 330 that extends at least partially through the casing, the stem 1010 may extend through the aperture/slit 330 and into the interior 240 when interacting with the casing 300. At the end of the stem 1010, the label button 1000 may include a label portion 1020 that includes the text 1030 of the label button 1000 (e.g., the manufacturer information, product information and/or user information).

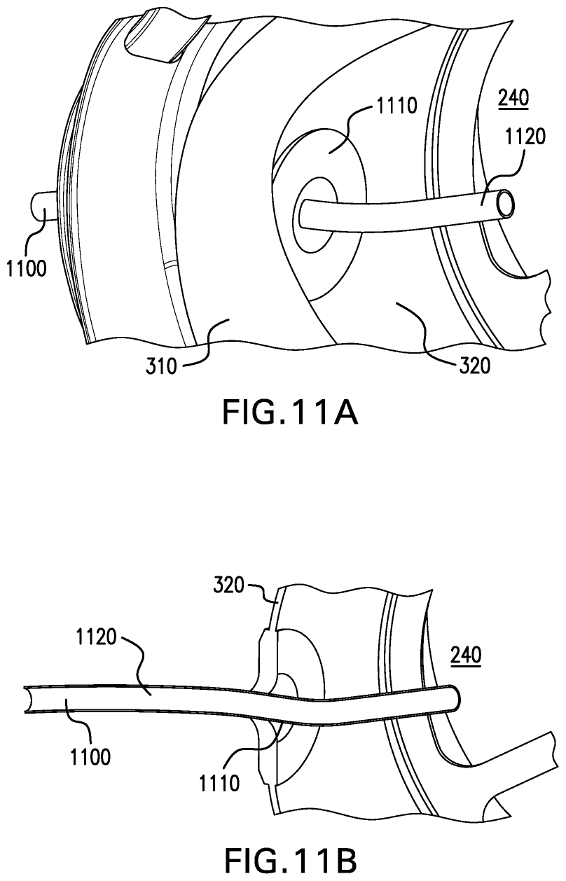

Once the user has donned the respirator mask system 100, it may be necessary for the user to wear the respirator mask system 100 for an extended period of time. To allow the user to hydrate while wearing the respirator mask system 100, another exemplary accessory may be a hydration system 1100 (FIGS. 11A and 11B). Like many of the other accessories, the hydration system 1100 may include a stem 1110 that engages the casing 300 from the interior and interacts/engages the aperture(s)/slit(s) 330 to open them. The hydration system 1000 may also include a tube 1120 that extends through the stem 1110 and into the interior 240 of the respirator mask system 100. One end of the tube 1120 may be fluidly connected to a hydrating fluid container (e.g., a cup, bottle, backpack, etc.) and the user may use the other end like a straw to drink from the container. In some embodiments, the end within the interior 240 may include additional features such as a valved mouthpiece to facilitate the user's drinking without allowing the hydrating fluid to leak into the interior 240.

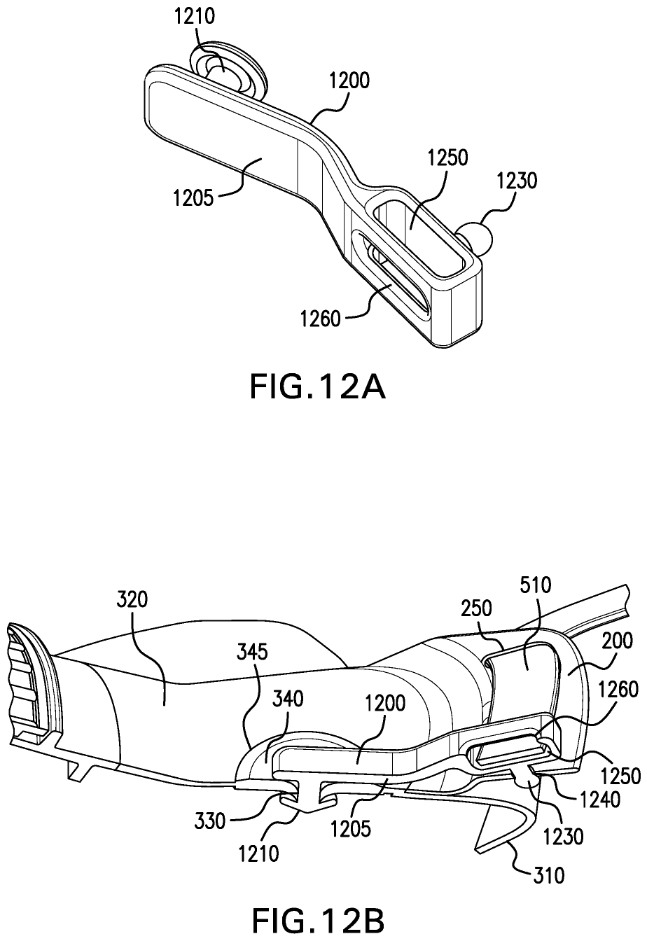

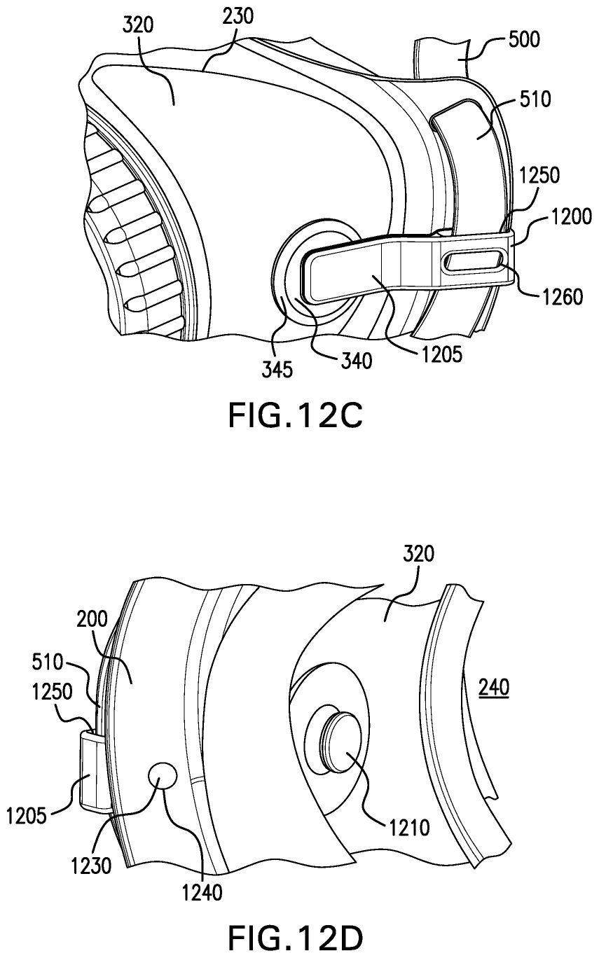

In addition to engaging with the casing 300, some accessories may also engage with the body 200. For example, FIGS. 12A-12D schematically show a strap retainer 1200 that includes a protrusion/feature 1230 that engages/interacts with the body 200. The strap retainer 1200 may include a retainer body 1205 and the stem 1210 may extend from the body 1205 and interact with the casing 300 and/or aperture(s)/slit(s) 330 in the manner described above for the other accessories to gain access to the interior 240 and secure the strap retainer 1200 to the casing 300. The body engagement protrusion 1230 may be located at the opposing end of the body 1205 and may extend at least partially into a hole 1240 in the body 200 of the respirator mask system 100 to secure the accessory to the body 200.

As the name suggests, the strap retainer 1200 may be used to help retain the head strap 500 when the respirator mask system 100 is donned by the user. Therefore, the strap retainer 1200 may have a channel 1250 extending through the body 1205 that receives the strap 510. Additionally, to allow the user to view length indicators on the strap 510, the body 1205 may have a window 1260 at the channel 1250. During tensioning of the strap 510, the user may be able to reproducibly tension the strap 510 and head strap 500 to the same tension and ensure proper positioning and fitment/sealing.

The embodiments of the invention described above are intended to be merely exemplary; numerous variations and modifications will be apparent to those skilled in the art. All such variations and modifications are intended to be within the scope of the present invention as defined in any appended claims.

1. A respirator mask system for protecting a user against inhalation of undesirable airborne substances within a surrounding environment when donned by the user, the respirator mask system comprising:
a body having a proximal portion with a first opening to an interior, the first opening configured to accommodate the user's face, and a main portion with a second opening to the interior, the body formed from a first material;
a casing attached to the body and configured to enclose the second opening and prevent the flow of air therethrough, the casing formed from a second material, the second material being softer than the first material;
a filter device configured to filter out at least a portion of the undesirable airborne substances between the surrounding environment and the interior while the user is breathing; and
an accessory having a stem and configured to interact with at least the casing, at least a portion of the accessory gaining access to the interior, the stem of the accessory engaging the casing when the accessory interacts with the casing.

2. A respirator mask system according to claim 1, wherein at least a portion of the casing circumscribes the first opening.

3. A respirator mask system according to claim 1, wherein the filter device is a disposable filter cartridge.

4. A respirator mask system according to claim 3, wherein body includes threads, the disposable filter cartridge configured to thread onto the body.

5. A respirator mask system according to claim 3, wherein the disposable filter cartridge is configured to snap onto the body.

6. A respirator mask system according to claim 1, further comprising:
a head strap configured to be placed around the head of the user, thereby securing the respirator mask system to the user.

7. A respirator mask system according to claim 6, wherein the head strap includes a locking clip configured to tension and secure the head strap.

8. A respirator mask system according to claim 1, wherein the casing includes at least one normally closed slit at least partially extending through the casing, at least a portion of the accessory acting upon the at least one normally closed slit when interacting with the casing.

9. A respirator mask system according to claim 8, wherein the casing includes an area having a variable wall thickness at least partially surrounding the at least one normally closed slit.

10. A respirator mask system according to claim 8, wherein the stem of the accessory has at least one protrusion configured to engage the at least one normally closed slit, thereby securing the accessory to the respirator mask system.

11. A respirator mask system according to claim 1, wherein the accessory is an exhalation valve system.

12. A respirator mask system according to claim 1, wherein the accessory is a fit-test port having a fit test grommet and the stem, the fit test grommet configured to engage an exterior of the casing, the stem configured to engage an interior of the casing and extend through the casing and fit test grommet.

13. A respirator mask system according to claim 1, wherein the accessory includes a sensor configured to monitor the interior or the surrounding environment, the stem having a housing that engages the casing and restricts access to the exterior.

14. A respirator mask system according to claim 13, wherein the sensor may include at least one selected from the group consisting of a carbon dioxide sensor, a contaminant sensor, a temperature sensor, a humidity sensor, and a pressure sensor.

15. A respirator mask system according to claim 1, wherein the accessory is a label button.

16. A respirator mask system according to claim 1, wherein the accessory is a hydration system, the hydration system including a tube extending from a fluid container to the interior.

17. A respirator mask system according to claim 1, wherein the accessory is a strap retainer, the stem configured to secure the strap retainer to the casing when engaged with the casing, the strap retainer including:
a strap retainer body extending from the stem, and
a channel extending through the strap retainer body and configured to receive a head strap and to allow the head strap to pass through the strap retainer body.

18. A respirator mask system according to claim 1, wherein the accessory includes a body interacting element configured to interact with the body.

19. A respirator mask system according to claim 18, wherein the body interacting element extends at least partially into a hole within the body when interacting with the body.

20. A method for protecting a user against inhalation of undesirable airborne substances within a surrounding environment, the method comprising:
providing a respirator mask system, the respirator mask system including:
a body having a proximal portion with a first opening to an interior, the first opening configured to accommodate the user's face, and a main portion with a second opening to the interior, the body formed from a first material,
a casing attached to the body and configured to enclose the second opening and prevent the flow of air therethrough, the casing formed from a second material, the second material being softer than the first material,
a filter device configured to filter out at least a portion of the undesirable airborne substances between the surrounding environment and the interior while the user is breathing,
an accessory having a stem and configured to interact with at least the casing, at least a portion of the accessory gaining access to the interior, the stem of the accessory engaging the casing when the accessory interacts with the casing,
a head strap configured to be placed over the head of the user;
placing the user's face adjacent the first opening of the body, the respirator mask system configured to seal against the user's face; and
securing the respirator mask system to the user by placing the head strap around the head of the user and tightening the head strap.
